(19) United States
(12) Patent Application Publication
(10) Pub. No.: US 2001/0041554 A1
(43) Pub. Date: Nov. 15, 2001

(54) REGISTRATION-BASED USER ZONE NOTIFICATION FOR WIRELESS HANDSETS

(75) Inventor: ADRIAN J. ROWELL, ARVADA, CO (US)

Correspondence Address: QWEST COMMUNICATIONS INTERNATIONAL INC, LAW DEPT INTELLECTUAL PROPERTY GROUP, 1801 CALIFORNIA STREET, SUITE 3800, DENVER, CO, 80202, US

(73) Assignee: Owest Communications International Inc., Denver, CO

(21) Appl. No.: 09/321,046

(22) Filed: May 27, 1999

(51) Int. Cl. H04M 11/00

(52) U.S. Cl. 455/406; 455/405

(57) ABSTRACT

In a wireless network provided with a plurality of cell sites having a coverage area and an associated billing zone, a method and system for providing a wireless mobile unit with an indication of which type of billing zone is associated with the cell site servicing the mobile unit includes registering a mobile unit located within the coverage area of a cell site with the cell site. After registration, the billing zone associated with the registered cell site is then determined. An indication is then provided to the mobile unit of the billing zone associated with the registered cell site. The mobile unit then displays a message to notify the user of the mobile unit of the billing zone associated with the cell site in which the mobile unit is registered.

### TECHNICAL FIELD

The present invention relates generally to wireless communication systems and methods and, more particularly, to a system and method for providing a wireless user with an indication of the billing zone associated with the cell site in which the wireless user is registered.

### BACKGROUND ART

Autonomous registration is an overhead wireless handset locating function used in a cellular system to identify the wireless handsets covered for service within a particular cell site, e.g., a cellular geographic service area. Autonomous registration may be time based and/or geographic based. In time based autonomous registration, the registration of a wireless handset is in response to the passage of a time interval as defined by a clock. Geographic based autonomous registration is based on the location of the wireless handset. For example, a roamer, i.e., a wireless handset away from its home territory, autonomously registers when it enters the territory of a new cell site.

Each wireless handset, when not engaged in making a call, continuously listens to a setup channel with control information from a cell site and transmits overhead messages to the cell site via a reverse signaling channel. Cell site identification signals generated by the base station of the cell site identify the presently serving cell site to the wireless handset. If the wireless handset begins to lose reception of its present identifying signal the wireless handset searches for a new better quality identification signal. If the new identification signal indicates that the wireless handset is in the service area of a new cell site, the wireless handset automatically registers with the base station of the new cell site.

Each cell site communicates with a mobile switching center. The mobile switching center keeps track of the location of the wireless handset by knowing which cell site the wireless handset is registered. The mobile switching center needs to know the location of the wireless handset for knowing where to page the wireless handset when the wireless handset is to receive a call.

A problem in the prior art is that although the mobile switching center knows which cell site the wireless handset is registered and, consequently, the location of the wireless handset, the user of the wireless handset is not aware of which type of billing zone is associated with the cell site servicing the wireless handset.

### SUMMARY OF THE INVENTION

Accordingly, it is an object of the present invention to provide a system and method for providing a wireless user with an indication of the location of the wireless user upon registration with a cell site.

It is another object of the present invention to provide a system and method for providing a wireless user with an indication of which type of billing zone the wireless user is located upon registration with a cell site.

In carrying out the above objects and other objects, the present invention provides a method for use in a wireless network provided with a plurality of cell sites each having a coverage area and an associated billing zone. The method provides an indication to a mobile unit located within a coverage area of a cell site of the billing zone associated with the cell site. The method includes registering a mobile unit located within the coverage area of a cell site with the cell site. The billing zone associated with the cell site in which the mobile unit is registered is then determined. An indication is then provided to the mobile unit of the billing zone associated with the registered cell site.

Further, in carrying out the above objects and other objects, the present invention provides a wireless network. The wireless network includes a plurality of cell sites, a mobile switching center, a signaling control point, and a message service center. Each of the plurality of cell sites has a coverage area and an associated billing zone. Each cell site is operable to register a mobile unit located within the coverage area of the cell site. The mobile switching center receives registration information indicative of the cell site in which a mobile unit is registered from the registered cell site. The signaling control point stores the billing zone associated with each cell site. The signaling control point receives the registration information from the mobile switching center and then selects the billing zone associated with the registered cell site. The message service center receives billing zone information indicative of the billing zone associated with the registered cell site from the signaling control point and then generates a message based on the billing zone information. The message service center provides the message to the mobile unit located within the coverage area of the registered cell site. The mobile unit displays the message to notify a user of the mobile unit of the billing zone associated with the registered cell site.

The advantages accruing to the present invention are numerous. For instance, the user of the mobile unit knows before making or receiving a call whether the user is located within a preferred billing zone. If the user is located within an expensive billing zone, the user may move to the coverage area of another cell site having an associated cheaper billing zone.

The above objects and other objects, features, and advantages of the present invention will be apparent from the following detailed description of the best mode for carrying out the invention when taken in connection with the accompanying drawings.

### BRIEF DESCRIPTION OF DRAWINGS

FIG. 1 illustrates a schematic of a typical cellular system geographical layout;

FIG. 2 illustrates the connections in the cellular system between a mobile unit and a cell site;

FIG. 3 illustrates a system for providing a mobile unit with an indication of the billing zone associated with the cell site in which the mobile unit is registered in accordance with the present invention; and

FIG. 4 illustrates a mobile unit having a display screen configured to provide a message to the user indicative of the billing zone associated with the cell site in which the mobile unit is registered.

### BEST MODE FOR CARRYING OUT THE INVENTION

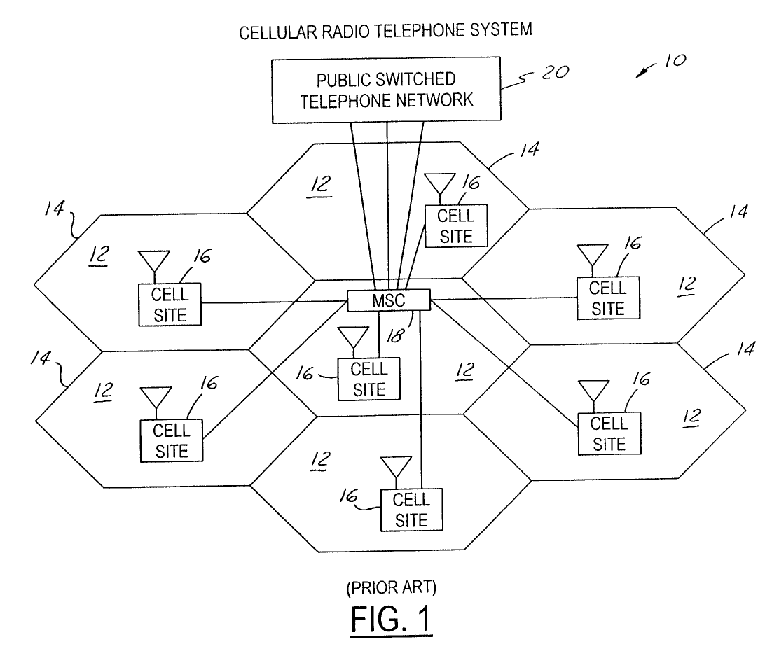

Referring now to FIG. 1, a schematic of a typical geographical layout of a cellular radiotelephone system 10 is illustrated. The radiotelephone service area is divided into a plurality of cells 12 each covering a defined and substantially contiguous geographical area as illustrated by geometric tiled hexagons 14. Each cell 12 includes a cell site 16 or base station which is a wireless communication and switching center for providing air communication with mobile radiotelephones. Each cell site 16 includes air radio communication equipment having antennas and land communication equipment. The land communication equipment includes trunk connections to a mobile switching center (MSC) 18 which couples cell sites 16 to a public switched telephone network (PSTN) 20.

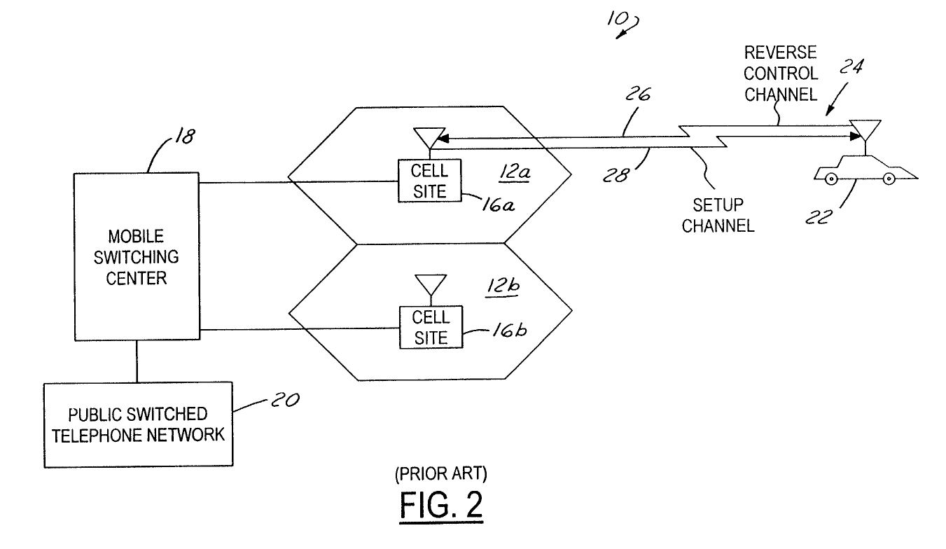

Referring now to FIG. 2, a cell site 16 communicates with a wireless handset such as a mobile unit 22. A wireless handset is a cellular phone. There are four main types of cellular phones: mobile, transportable, portable, and personal. Mobile unit 22 includes the cellular telephone equipment installed in an automobile such as a transceiver, handset, and an antenna. Cell site 16a communicates with a plurality of mobile units via a plurality of different radio channels. Some channels are dedicated to voice transmissions and others are dedicated to various overhead control message transmissions. An overhead air radio transmission channel 24 is established between mobile unit 22 and cell site 16a. A radio channel for overhead messages directed from mobile unit 22 to cell site 16a is designated as a reverse control channel 26. Autonomous registrations are transmitted over reverse control channel 26. Call setups, including cell site identification information, are transmitted from cell site 16a to mobile unit 22 over a setup channel 28.

As shown in FIG. 2, cell site 16a is connected with another cell site 16b to MSC 18 through respective T1 lines. MSC 18 is connected to PSTN 20 through system signaling 7 (SS7) protocol. If mobile unit 22 leaves the area covered by cell site 16a and enters the area covered by adjacent cell site 16b, the mobile unit loses the setup and reverse control of cell site 16a. The new identifying information on the corresponding setup channel of adjacent cell site 16b may cause mobile unit 22 to register in the adjacent cell. If mobile unit 22 remains in coverage area of cell site 16a, the time information provided by the cell site causes the mobile unit to periodically to register.

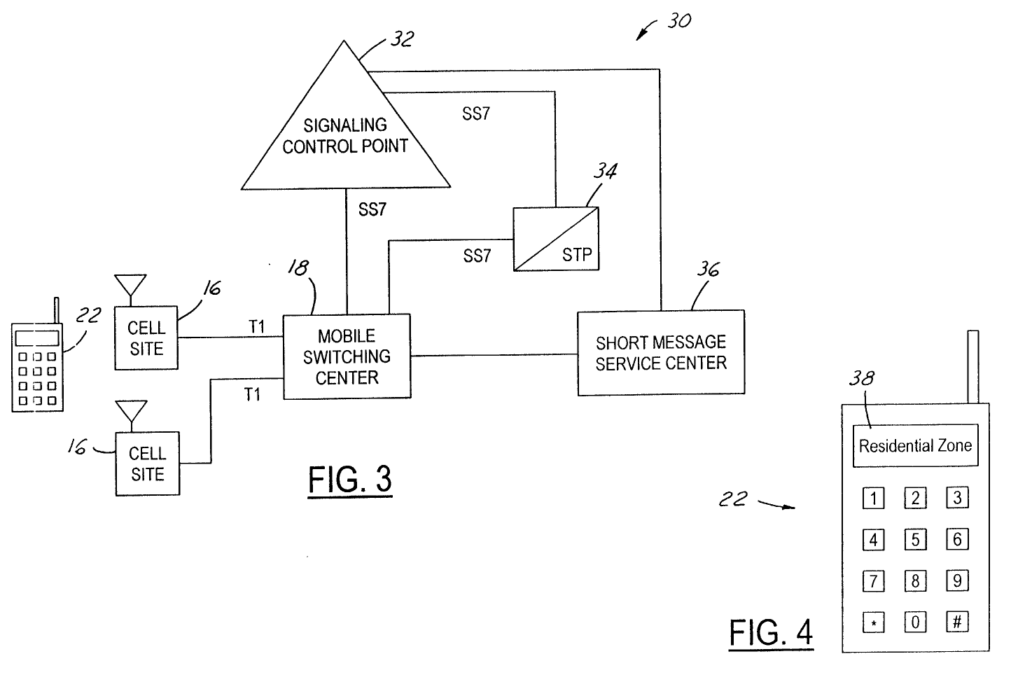

Referring now to FIG. 3, a system 30 for providing a mobile unit 22 with an indication of the billing zone associated with the cell site in which mobile unit 22 is registered in accordance with the present invention is shown. In system 30, MSC 18 is connected to a signaling control point (SCP) 32 and a signal transfer point (STP) 34 through SS7 protocol. MSC 18 is also connected to a short message service center 36.

Upon registration of mobile unit 22 with a cell site 16, the cell site notifies MSC 18 of the registration. MSC 18 then provides the registration information to SCP 32. The registration information includes the identification of cell site 16. SCP 32 is a remote database that includes a location billing application. The location billing application of SCP 32 stores a billing zone for each cell site. SCP 32 knows the billing zone that applies to mobile unit 22 by knowing the registered cell site.

Cell sites 16 service areas that are public zones, residential zones, commercial zones, business zones, etc. Each zone has a corresponding billing charge associated with making calls in that zone. For example, a cellular provider may charge a reduced fee when servicing mobile units within a residential zone because of the relatively light cellular traffic. The cellular provider may charge a premium fee when servicing mobile units within a business zone because of the relatively heavy cellular traffic. In addition to geographic location, the type of a particular zone may depend on temporal factors such as the time of day. For example, a business zone may be considered a residential zone during non-business hours. The location billing application of SCP 32 stores the billing zone for each cell site and uses this information to properly bill the user of the mobile unit for servicing a call.

Although SCP 32 knows which zone applies to mobile unit 22, the user of the mobile unit is unaware of the billing zone associated with the registered cell site. An advantage of the present invention is that system 30 provides an indication to the user of which type of billing zone mobile unit 22 is located. Accordingly, the user of mobile unit 22 can decide whether or not to make or receive a call depending upon the billing zone. The user of mobile unit 22 can also move to another location to register with a different cell site having an associated different billing zone before making or receiving a call.

To provide the user of mobile unit 22 with an indication of which type of billing zone the user is located, SCP 32 transmits a message to short message service center 36 regarding the zone status of the mobile unit upon receiving registration information from MSC 18. Short message service center 36 then transmits to MSC 18 a message containing the zone status information. MSC 18 then provides the zone status message to mobile unit 22 via cell site 16.

Referring now to FIG. 4, mobile unit 22 includes a display screen 38 configured to provide a visual indication to the user of the zone status message. The zone status message may be phrases such as “residential zone”, “business zone”, “public system”, etc. The message provides a visual indication to the user of mobile unit 22 of the applicable billing zone.

Thus, it is apparent that there has been provided, in accordance with the present invention, a system and method for providing a wireless user with an indication of which type of billing zone the wireless user is located upon registration with a cell site that fully satisfy the object, aims, and advantages set forth above.

While the present invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

What is claimed is:

1. In a wireless network provided with a plurality of cell sites each having a coverage area and an associated billing zone, a method for providing an indication to a mobile unit located within a coverage area of a cell site of the billing zone associated with the cell site, the method comprising:
registering a mobile unit located within the coverage area of a cell site with the cell site;
determining the billing zone associated with the cell site in which the mobile unit is registered; and
providing an indication to the mobile unit of the billing zone associated with the registered cell site.

2. The method of claim 1 wherein determining the billing zone comprises:
storing the billing zone associated with each cell site in a database; and
selecting the billing zone associated with the registered cell site from the database.

3. The method of claim 1 wherein providing an indication comprises:
generating a message on a display screen of the mobile unit indicative of the billing zone associated with the registered cell site.

4. The method of claim 1 wherein:
registering a mobile unit located within the coverage area of a cell site with the cell site occurs when the mobile unit is powered on.

5. The method of claim 1 wherein:
registering a mobile unit located within the coverage area of a cell site with the cell site occurs when the mobile unit enters the coverage area of the cell site.

6. The method of claim 1 wherein:
the type of billing zones includes residential and business zones.

7. In a wireless network provided with a plurality of cell sites each having a coverage area and an associated billing zone, a mobile switching center, a signaling control point, and a message service center, a method for providing an indication to a mobile unit located within a coverage area of a cell site of the billing zone associated with the cell site, the method comprising:
registering a mobile unit located within the coverage area of a cell site with the cell site;
storing the billing zone associated with each cell site in a database of the signaling control point;
providing registration information indicative of the cell site in which the mobile unit is registered from the registered cell site to the mobile switching center;
providing the registration information from the mobile switching center to the signaling control point;
selecting the billing zone associated with the registered cell site from the database of the signaling control point;
providing billing zone information indicative of the billing zone associated with the registered cell site from the signaling control point to the message service center;
generating a message based on the billing zone information at the message service center;
providing the message to the mobile unit via the mobile switching center and the registered cell site; and
displaying the message at the mobile unit to notify a user of the mobile unit located within the coverage area of the registered cell site of the billing zone associated with the registered cell site.

8. The method of claim 7 wherein:
registering a mobile unit located within the coverage area of a cell site with the cell site occurs when the mobile unit is powered on.

9. The method of claim 7 wherein:
registering a mobile unit located within the coverage area of a cell site with the cell site occurs when the mobile unit enters the coverage area of the cell site.

10. A wireless network comprising:
a plurality of cell sites each having a coverage area and an associated billing zone, each cell site operable to register a mobile unit located within the coverage area of the cell site;
a mobile switching center for receiving registration information indicative of the cell site in which a mobile unit is registered from the registered cell site;
a signaling control point for storing the billing zone associated with each cell site, wherein the signaling control point receives the registration information from the mobile switching center and then selects the billing zone associated with the registered cell site;
a message service center for receiving billing zone information indicative of the billing zone associated with the registered cell site from the signaling control point and then generating a message based on the billing zone information, wherein the message service center provides the message to the mobile unit located within the coverage area of the registered cell site, wherein the mobile unit displays the message to notify a user of the mobile unit of the billing zone associated with the registered cell site.

11. The system of claim 10 wherein:
the mobile unit registers with a cell site as soon as the mobile unit is powered on within the coverage area of the cell site.

12. The system of claim 10 wherein:
the mobile unit registers with a cell site as soon as the mobile unit enters the coverage area of the cell site.
